(19) United States
(12) Patent Application Publication
(10) Pub. No.: US 2021/0326698 A1
(43) Pub. Date: Oct. 21, 2021

(54) TRAINING AND APPLYING MODELS WITH HETEROGENOUS DATA

(71) Applicant: KONINKLIJKE PHILIPS N.V., Eindhoven (NL)

(72) Inventor: Aleksandr Bukharev, Moscow (RU)

(21) Appl. No.: 17/153,960

(22) Filed: Jan. 21, 2021

Related U.S. Application Data
(60) Provisional application No. 63/012,337, filed on Apr. 20, 2020.

(51) Int. Cl. G06N 3/08; G06N 3/04

(52) U.S. Cl. CPC G06N 3/08; G06N 3/0454

(57) ABSTRACT

Techniques described herein relate to training artificial intelligence and machine learning models on non-iid or heterogeneous data, for adapting previously-trained models to new data sources, and for using these models to make inferences. In various embodiments, data may be obtained from one or more data sources that are available in a given domain. The data may be in a domain-specific form that is specific to the given domain. The data may be processed using one or more trained machine learning models. The one or more trained machine learning models may include: a domain-specific set of weights that is tailored to the given domain, and a global set of weights that is shared across a plurality of domains of a federated learning system. An outcome of the process may be provided at one or more output components.

### TECHNICAL FIELD

Various embodiments described herein are directed generally to artificial networks and machine learning. More particularly, but not exclusively, various methods and apparatus disclosed herein relate to training artificial intelligence and machine learning models on data that is not independent and identically distributed (“non-iid”), also referred to herein as heterogeneous data, as well as for using these models to make inferences.

### BACKGROUND

The efficacy of machine learning and artificial intelligence tends to increase with greater amounts of training data. In industries such as healthcare, myriad data may be available, but that data may be heterogeneous from one data source/owner, or “domain,” to another. For example, different hospitals may employ similar contrast sequences when operating magnetic resonance imaging (“MRI”) but otherwise, visual characteristics of MRI imagery may vary from hospital to hospital, depending on a variety of factors related to personnel, policy, equipment, etc. Similarly, different medical facilities may employ different energies and/or other settings when taking computed tomography (“CT”) scans, ultrasound images, etc.

Accumulation of data from heterogeneous sources is also made challenging by various economic, regulatory, and/or privacy-related factors. Some of these concerns, particularly privacy, may be addressed in part using a “model-to-data” approach, where data is kept with data owners, e.g., on their own computing systems and/or within their own networks/firewalls, and the models that are used to process the data are distributed. To train these models, synchronous training approaches such as federated learning may be applied. However, application of these approaches remains challenging in environments such as health care where the data is not independent and identically distributed (“non-iid”).

### SUMMARY

The present disclosure is directed to methods and apparatus for training artificial intelligence and machine learning models on non-iid or heterogeneous data, for adapting previously-trained models to new data sources, and for using these models to make inferences. More particularly, but not exclusively, implementations are described herein for learning and applying local and global models to heterogeneous data, including distributed private datasets, without necessarily sharing this distributed data with a centralized server or entity. For example, in a model-to-data environment such as a federated learning environment, one or more machine learning models may include multiple sets of weights. Some of these weights may be “global” weights that are shared among multiple domains of the model-to-data environment. Other sets of these weights may be “domain-specific” sets of weights that tailored to particular domains.

As used herein, a “domain” refers to one or more data sources that are owned, accessible to, and/or controlled by a particular entity. These entities may sometimes be referred to herein as “data owners,” but that should not be taken to mean they necessarily own the data. In the healthcare context, a domain may refer to one or more hospitals that share data sources such as a hospital information system (“HIS”), electronic health records, equipment such as medical equipment and/or sensors that generate data, etc. The hospitals may also have treatment and/or equipment policies in place to ensure that data generated by various data sources, such as MRIs, CT scans, etc., is uniform within that domain. Put another way, data stored in data source(s) within a single domain may be, at least for the most part, homogenous.

By contrast, data from data source(s) of one domain may not be in the same form as data from data source(s) of another domain. One hospital or hospital system may have data that is heterogeneous relative to data from another hospital or hospital system. As noted in the background, training and applying artificial intelligence and/or machine learning models across different domains—and therefore using heterogeneous data—can be challenging. Techniques described here may facilitate training of model(s) in model-to-data (e.g., federated learning) environments by training both global model weights and, for each domain in the model-to-data environment, local model weights. Consequently, each domain may be equipped with what can be referred to as an “adaptor”—e.g., a local set of machine learning model weights or an entire local model—that transforms or otherwise converts data in a form that is specific to that domain to a form that is “global,” “normalized,” or more generally, domain-independent across the entire model-to-data environment.

Generally, in one aspect, a method implemented using one or more processors may include: obtaining data from one or more data sources that are available in a given domain, wherein the data is in a domain-specific form that is specific to the given domain; processing the data using one or more trained machine learning models, wherein the one or more trained machine learning models include: a domain-specific set of weights that is tailored to the given domain, and a global set of weights that is shared across a plurality of domains of a federated learning system; and providing, at one or more output components, an outcome of the processing.

In various embodiments, the global weights may be learned using a plurality of gradients computed at the plurality of domains of the federated learning system, and the domain-specific weights may be learned using local gradients computed within the given domain. In various embodiments, the domain-specific weights may be isolated from the global weights during training.

In various embodiments, the domain-specific weights may correspond to an affine transform. In various embodiments, one or more of the trained machine learning models may include a convolutional neural network. In various embodiments, the domain-specific set of weights and the global set of weights may be incorporated into a single trained machine learning model of the one or more trained machine learning models during the processing. In various embodiments, the domain-specific set of weights and the global set of weights may be learned during combined training of one or more of the trained machine learning models. In various embodiments, two or more of the obtaining, processing, and providing may be performed by a computing device associated with the given domain.

In another aspect, a method for federated learning using one or more processors may include: obtaining data from one or more data sources that are available in a given domain, wherein the data is in a domain-specific form that is specific to the given domain; processing the data using one or more machine learning models, wherein the one or more trained machine learning models include: a global set of weights that is shared across a plurality of domains of the federated learning system, and a domain-specific set of weights that is isolated from the global set of weights; and based on one or more outcomes of the processing, training the one or more machine learning models.

In various embodiments, the training may include alternating between updating the global set of weights and updating the domain-specific set of weights. In various embodiments, the global set of weights may be held constant during training of the domain-specific set of weights, and the domain-specific set of weights are held constant during training of the global set of weights. In various embodiments, updating the global set of weights may include: computing a local gradient for the global set of weights using the data obtained from the one or more data sources available in the given domain; and transmitting data indicative of the local gradient to a federated learning central server, wherein the federated learning central server uses the local gradient and other local gradients computed in other domains participating in the federated learning to train the global set of weights.

In addition, some implementations include one or more processors of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating various principles of the embodiments described herein.

FIG. 1 illustrates an example environment in which selected aspects of the present disclosure may be implemented.

FIG. 2 illustrates an example of how global and local sets of weights may be applied to data within a given domain of a multi-domain, model-to-data environment.

FIG. 3 illustrates another example environment in which selected aspects of the present disclosure may be implemented.

FIG. 4 depicts an example method for practicing selected aspects of the present disclosure.

FIG. 5 depicts an example computing system architecture.

### DETAILED DESCRIPTION

The efficacy of machine learning and artificial intelligence tends increase with greater amounts of training data. However, in industries such as healthcare, myriad data may be available, but that data may be heterogeneous from one data source/owner, or “domain,” to another. Accumulation of data from heterogeneous sources is also made challenging by various economic, regulatory, and/or privacy-related factors. Some of these concerns may be addressed in part using a “model-to-data” approach. To train these models, synchronous training approaches such as federated learning may be applied. However, application of these approaches remains challenging in environments such as health care where the data is not independent and identically distributed (“non-iid”).

In view of the foregoing, various embodiments and implementations of the present disclosure are directed to for training artificial intelligence and machine learning models on non-iid or heterogeneous data, and for adapting previously-trained models to new data sources. More particularly, implementations are described herein for learning and applying local and global models/weights to heterogeneous data.

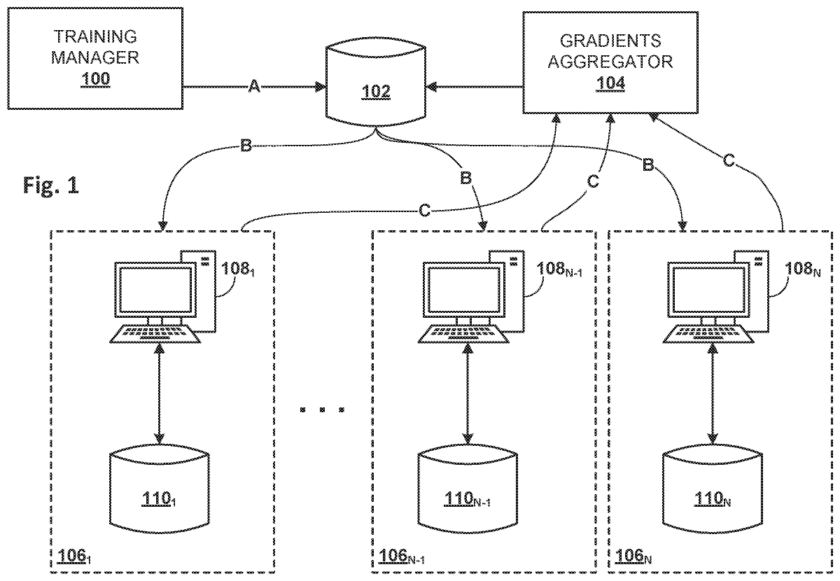

FIG. 1 schematically depicts an example model-to-data environment in which selected aspects of the present disclosure may be employed. In examples that will be described herein, federated learning is employed alongside selected aspects of the present disclosure. However, this should not be taken as limiting, and techniques described herein may be applicable with other model-to-data paradigms. In the distributed environment of FIG. 1, a training manager 100, a global secure database 102, and a gradients aggregator 104 may be “centralized” components that serve a plurality of domains 106_{1-N}. Any of these components may be implemented using any combination of hardware and computer-readable instructions, and may be implemented on a single computing device (e.g., a central server) or across multiple computing devices. Moreover, any of components 100, 102, and/or 104 may be combined with each other.

As noted previously, domains 106_{1-N} may correspond to or include respective data source(s) 110_{1-N} that each store data in a form that is specific to the respective domain 106. For example, first domain 106₁ may be a first healthcare system, and data source(s) 110₁ in first domain 106₁ may include any source of data (e.g., EMRs, sensor data, CT/MRI/X-ray imagery, etc.) that is generated, maintained, and/or controlled by entities associated with that domain 106₁, such as hospitals or clinics under the healthcare system's umbrella. Domain 106_{N-1} may represent a different healthcare system with different hospitals and/or clinics that store (in data source(s) 110_{N-1}) data in another form, specific to domain 106_{N-1}, that is different from the domain-specific form of first domain 106₁. And so on.

Federated Learning (“FL”) is an example of a distributed machine-learning algorithm or model(s) that may also be referred to more generally as a “model-to-data” paradigm. The model(s) may be trained based on, for instance, a large batch of training data using techniques such as averaging stochastic gradient descent (“SGD”). With FL, each training iteration may include one or more of: choosing the data-sources to run optimization; sending the model(s) (e.g., model weights) to each domain, training the model(s) on domain-specific (e.g., private) data within each domain; aggregating the resulting “local” gradients from the multiple domains; and updating the model weights at a central server based on the local gradients received from domains 106_{1-N}.

In FIG. 1, during each training iteration, training manager 100 may be configured to manage artificial intelligence (“AI”) and/or machine learning (ML″) model updates, which may include, for instance, locally-computed gradients received from domains 106_{1-N}. Training manager 100 may also be configured to aggregate and store training metrics, and choose domains 106 (e.g., data owners) having data suitable for training (not all data owners and/or domains may be able or willing to participate in training). With these model updates, training metrics and selected domains (collectively, “training parameters”) determined, training manager 100 may transfer (A) these training parameters to the global secure database 102. The model(s) updates may then be transferred (B), e.g., by training manager 100, from global secure database 102 to individual domains 106. As shown in FIG. 1, each domain may include one or more domain-specific computing devices 108 or apparatus, such as workstations, laptops, tablet computers, smart phones, etc., that receive these model(s) updates.

Next, training techniques such as back propagation may be applied, e.g., by training manager 100 and/or locally at a domain-specific computing device 108, to compute local gradients within each domain 106 using local data in a domain-specific form from the respective data source(s) 110 of that domain 106. In some embodiments, the objective function used during this local training may be the same across domains 106_{1-N}. Next, the local gradients may be combined, e.g., compressed, and transferred (C) to gradients aggregator 104. Gradients aggregator 104 may aggregate these local gradients with each other and relocate the updated model(s) in global secure database 102.

As noted previously, in order to obtain sufficient training data to train accurate models in a federated learning environment, it may be necessary to obtain heterogeneous data from multiple different domains. Large amounts of training data is especially important to avoid biases against outlier inferences such as rare diseases or health conditions with low prevalence. Federated Learning may suffer from data heterogeneity. Techniques such as sharing small, balanced and representative subsets of public data between domains, and/or Sparse Ternary Compression (“STC”), may address some of these issues. However, the former can lead to overfitting, not to mention gathering balanced and representative data may be difficult. STC is based on a technique known as “gradient sparsification” that reduces the amount of data exchanged between a central FL entity and multiple different domains. However, STC alone may not address the situation in which data across the multiple domains is heterogeneous.

Accordingly, in some embodiments, while all parameters of the models may be trained synchronously and/or globally, some weights associated with those models may be isolated and trained locally, e.g., within domains 106_{1-N} using domain-specific data. These domain-specific sets of weights, or “local” weights, may learn domain-specific transformations of data and/or features obtained from domain-specific data source(s) 110. Consequently, the domain-specific sets of weights may be used, e.g., as their own standalone “adaptor” models or as parts of a larger model that may also include other, non-domain-specific (or “global”) weights, to transform or normalize domain-specific data for analysis. Meanwhile, the other global sets of weights associated with the AI and/or ML models may be trained to extract task-specific features of normalized and/or domain-independent data. As a result, a repository of models that include both global sets of weights and domain-specific sets of weights may be generated and stored, e.g., in global secure database 102 and/or across domain data sources 110_{1-N}.

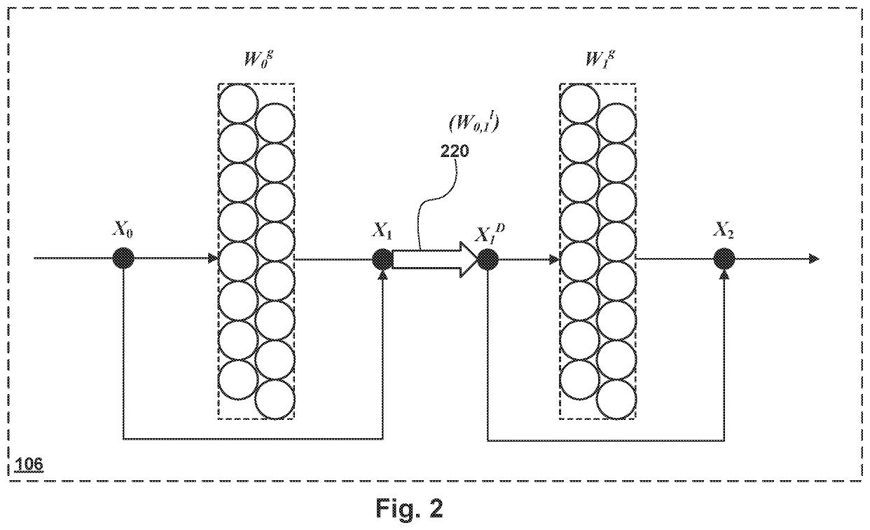

FIG. 2 schematically depicts an example of how local and global sets of weights of one or more models may be applied to domain-specific data. These weights and the models they comprise may be applied within a domain 106, e.g., by a domain-specific computing device 108, and/or at a centralized server (e.g., 100-104). In this example, global weights w₀^{g} and w₁^{g} are available within domain 106. A local set of weights w_{0,1}^{l} are represented by an adaptor 220. Global weights w₀^{g} and w₁^{g} may be available across all domains, whereas local weights w_{0,1}^{l} may be specific to domain 106. In some embodiments, the local and global sets of weights combine to form weights of a deep learning model such as a convolutional neural network, other types of neural networks, or more generally, other types of machine learning models.

In this example, the input data X₀ is in a form that is specific to domain 106. For example, X₀ may include medical data such as MRI imagery that is generated using settings or other equipment parameters dictated by a particular hospital, or system of clinics. Numerous other types of data are contemplated, this is just an example. In order to reduce the influence of data heterogeneity on the ultimate output, X₂, adaptor 220 is added between the respective global sets of weights, w₀^{g} and w₁^{g}.

As noted above, global weights w₀^{g} and w₁^{g} may be available across all domains, and may be updated/trained iteratively by counting local gradients from multiple domains (106_{1-N}) in coordination with, for instance, centralized training manager 100. By contrast, the domain-specific/local model(s)/weights w_{0,1}^{l} represented by adaptor 220 may transform features X₁ output from the first global weights w₀^{g} (e.g., extracted from shifted input data X₀) into domain-independent features X₁^{D}.

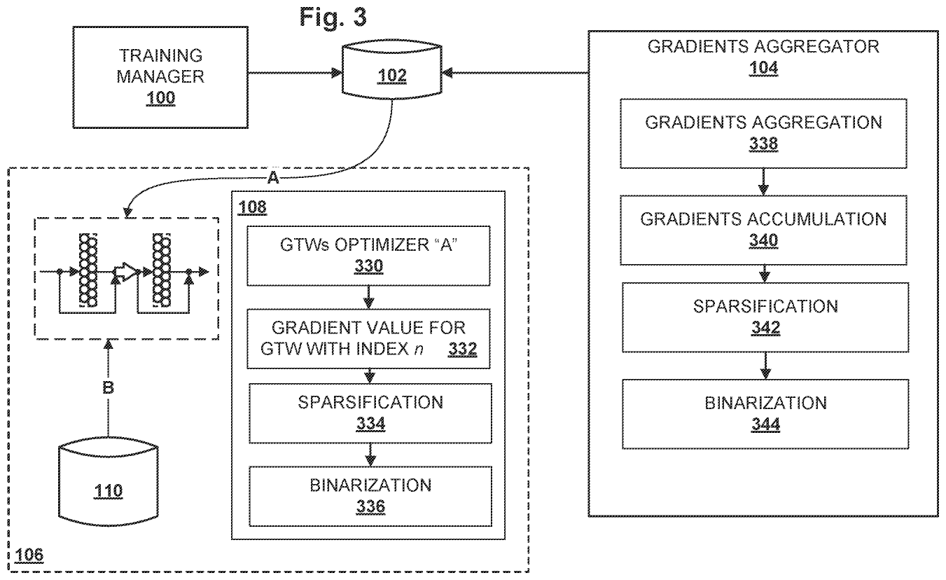

During a training iteration, training may alternate between training the global weights w₀^{g} and w₁^{g} and the local weights w_{0,1}^{l}. For example, one or more iterations of techniques such as SGD may be applied to optimize local weights w_{0,1}^{l}. During this training iteration, global weights w₀^{g} and w₁^{g} may be held constant. Then, during another training iteration, local weights w_{0,1}^{l} may be held constant and global weights w₀^{g} and w₁^{g} may be trained/updated, e.g., by using SGD or other techniques to compute a local gradient for domain 106. Techniques for training global weights w₀^{g} and w₁^{g} using these local gradients will be described in more detail with respect to FIG. 3.

In some embodiments, adaptor 220 (and the local weights w_{0,1}^{l} it represents) may take the form of an affine transform and/or differentiable function. For example, in embodiments wherein global and/or local weights form a convolutional neural network, adaptor 220 may represent an equation such as the following:

(Xₗ^{D})_{ch,h,w}=b_{ch}+(1+a_{ch})×(Xₗ)_{ch,h,w}

wherein output X₁ of one convolution (computing using global weights w₀^{g}) corresponds to a tensor value located in position channel, height, width, or ch, h, and w. One possible definition of a model represented by adaptor 220 may be an affine function t(x_{ch,h,w}) which rescales and biases a feature map X₁ as follows:

x_{ch,h,w}^{t}=t(x_{ch,h,w})=b_{ch}+(1+a_{ch})×(Xₗ)_{ch,h,w}

Here, {a_{ch}, bₐₕ} represent locally-trainable weights (e.g., w_{0,1}^{l}), and may correspond to a relatively small fraction of the total weights applied by the overarching convolutional neural network that also includes the global weights.

In FIG. 2, adaptor 220 and local weights w_{0,1}^{l} are depicted in between separate sets of global weights w₀^{g} and w₁^{g}, but this is not meant to be limiting. In various embodiments, the order may be rearranged. For example, adaptor 220 could be upstream of all global weights, e.g., so that domain-specific data is normalized to be domain-independent first, and then is processed using the global weights. Alternatively, adaptor 220 could be downstream of all global weights, e.g., so that the global weights process the data in its domain-specific form, and then the output of this global weight processing is transformed using adaptor into a domain-independent form. Moreover, it is possible to employ more than one adaptor within a domain, e.g., between, upstream, or downstream from sets of global weights.

In addition to training distributed models from scratch, techniques described herein may be applicable, for instance, to onboard existing data sources (e.g., from a new domain) that store data in a form specific to that domain, or to update existing adaptors (220) if existing data generation processes change within a domain. The adaptor 220 (and the local weights w^{l} it represents) trained for one domain may also provide a mechanism for bootstrapping a new adaptor to be tailored to a newly-onboarded domain. For example, the new domain's data owner may prepare validation and test samples from their own, domain-specific data. These samples may then be used to search existing adaptors for other domains to find the closest adaptor 220, e.g., using a “winner takes all” rule where pᵢ stands for “predictions” of the model represented by global and local weights (w^{g} and wᵢ^{l}) and L is an objective function:

w^{l}=argminᵢ(L(pᵢ,y_{validation}))

In some cases, if the chosen weights w^{l} show acceptable prediction quality on the test sample subset, they can be used for pseudo-labeling, e.g., annotating unlabeled samples for use as a training set, and the new adaptor may be retrained. If the training subset and model with w^{l} are on the same computing device (e.g., within a domain 106), any kind of optimizers and/or regularizations may be used for training.

FIG. 3 depicts in more detail than FIG. 1 a non-limiting example of how data may flow between and by processed by the various components in order to train global weights w₀^{g} and w₁^{g}. For simplicity and clarity, only a single domain 106 is depicted in FIG. 3, but it should be understood that multiple domains with their own domain-specific data may be present. Transferring model updates between domain 106 and the server components (e.g., training manager 100, global secure database 102, gradients aggregator) may involve large amounts of data, which could overburden network(s) (not depicted) between the various components. Accordingly, in some embodiments, sparse ternary compression (“STC”) may be employed as part of an optimization technique for the global weights w₀^{g} and w₁^{g}. This reduces the amount of data transferred between the various components.

With STC, not all global weights need necessarily be updated at each iteration. Rather, domains may be selected at each iteration, and local gradients obtained therefrom. The selection procedure may or may not assign equal selection probability to each domain. In some embodiments, domain-specific computing device 108 may perform operations associated with blocks 330-336. At arrow A, stochastic approximation(s) of model gradients may be obtained and counted, e.g., by domain-specific computing device 108. A “lookahead” meta-optimizer may be applied at block 330 to extract a local gradient for domain 106 using local, domain-specific labels and data obtained from local data storage 110. In some embodiments, a equation such as the following may be employed to determine a local gradient Δwₙ^{g} for domain 106 at iteration n:

$$Δ {w}_{n}^{g} = \frac{A ( {w}_{n}^{g} , L , n ) - {w}_{n}^{g}}{n} .$$

At block 332, the local gradients may be summed with local gradients computed during previous iteration(s). In some embodiments, an equation such as the following may be employed to determine a local gradient value Bₙ^{g}(t) at a current time t for the global weights with the index n:

Bₙ^{g}(t)=Bₙ^{g}(t−1)+Δwₙ^{g}(t)

At block 334, STC sparsification may be employed to transfer to the server only some number (top_k) of local gradients with maximum values. In some embodiments, an equation such as the following may be employed as part of the sparsification of block 334:

$$δ {w}_{n}^{g} = \{ \begin{matrix}{B}_{n}^{g} , if {B}_{n}^{g} \geq {Q}_{k} ( {B}^{g} ) \\ 0 , otherwise\end{matrix} {B}_{n}^{g} = \{ \begin{matrix}0 , if δ {w}_{n}^{g} \\ {B}_{n}^{g} , otherwise\end{matrix}$$

δwₙ^{g} and Δwₙ^{g} represent local gradients. The delta sign “Δ” represents the stochastic approximation(s) of model gradients. The sign δ represents transformed gradients (after sparsification and binarization). δwₙ^{g} is the model update transferred from domain 106 and the server components Δwₙ^{g} and Bₙ^{g} are intermediate states of δwₙ^{g} “B” is a buffer to accumulate the gradients Δwₙ^{g} over the federated updates which cannot pass the sparsification.

At block 336, as part of a process referred to as “binarization,” various values may be further compressed prior to being transferred to the server(s), e.g., using an equation such as the following:

δwₙ^{g}=mean(δw^{g})×sign(δwₙ^{g})

Once the data indicative of the local gradient(s) is transferred to the server(s) (e.g., 100-104) by all participating domains (e.g., 106_{1-N}), control may pass to gradients aggregator 104. At block 338, gradients aggregator 104 may perform “gradients aggregation” on the local gradients received from the participating domains. These may be aggregated, e.g., using a weighted sum and/or equation such as the following:

δwₙ^{g}=Σaₙ×δwₙ^{g}

The coefficients aₙ may depend on the domain's characteristics, such as the total number of training samples, data diversity, number of annotators, etc.

Before the results of the global weight optimization are returned to domain(s) 106, they may once again be compressed at blocks 340-344. At block 340, gradients may be accumulated using an equation such as the following:

Bₙ(t)=Bₙ(t−1)+δwₙ(t)

This equation is very similar to the equation above provided for block 332. At blocks 342 and 344, similar operations as were performed at blocks 334 and 336 may be performed once again to compress the data prior to transfer to domain(s) 106.

The combination of accumulation (332, 340) and sparsification (334, 342) may enable synthetic accumulation of very large batches of data, and may result in automatic application of zero-norm regularization. This may stabilize convergence of the objective, while causing significantly reduced amounts of data to be exchanged, easing network burden. And the binarization of block 336 protects against indirect data leakage due to its irreversibility.

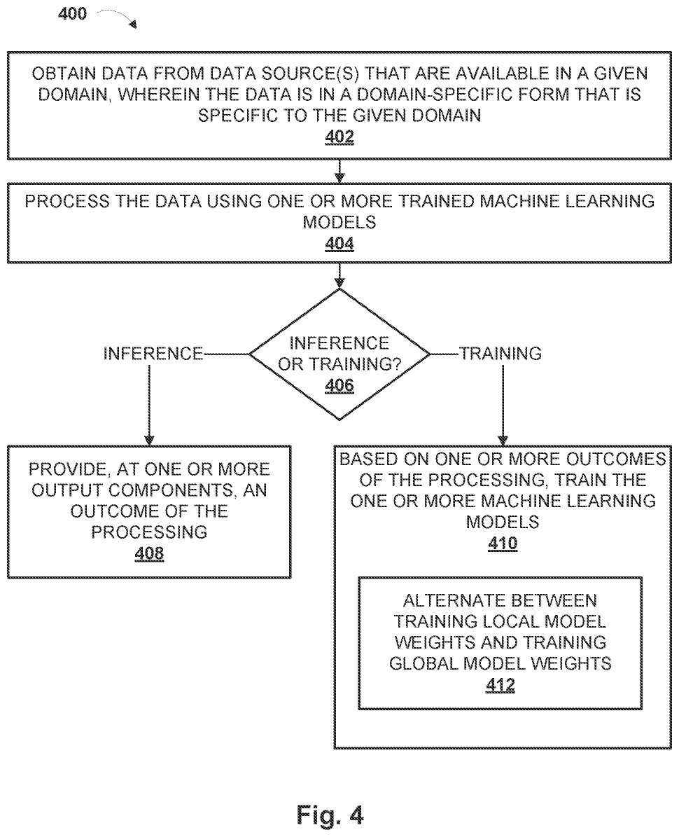

FIG. 4 illustrates a flowchart of an example method 400 for practicing selected aspects of the present disclosure. The steps of FIG. 4 can be performed by one or more processors, such as one or more processors of the various computing devices/systems described herein. For convenience, operations of method 400 will be described as being performed by a system configured with selected aspects of the present disclosure. Other implementations may include additional steps than those illustrated in FIG. 4, may perform step(s) of FIG. 4 in a different order and/or in parallel, and/or may omit one or more of the steps of FIG. 4.

At block 402, the system, e.g., by way of training manager 100 or a domain-specific computing device 108, may obtain data from one or more data sources (e.g., 110) that are available in a given domain 106. The data may be in a domain-specific form that is specific to the given domain 106, and data across different domains may be heterogeneous.

At block 404, the system may process the data using one or more trained machine learning models, e.g., CNNs, other types of neural networks, support vector machines, etc. In various embodiments, the one or more trained machine learning models may include both a domain-specific set of weights (e.g., local weights w_{0,1}^{l}) that is tailored to the given domain, and a global set of weights (e.g., w₀^{g} and w₁^{g}) that is shared across a plurality of domains of a federated learning system.

From here, at block 406, processing may proceed in two different ways. If the model(s) are already trained and are being used to make inferences, then method 400 may proceed to block 408, at which point the system may provide, e.g., at one or more output components of domain-specific computing device 108 or elsewhere, an outcome of the processing. For example, the outcome may be medical predictions based on the underlying local data. As described herein, while the underlying local data may be in a domain-specific form, but the outcome may be normalized to be homogeneous across domains.

Back at block 406, if the model(s) are undergoing training, then method 400 may proceed to block 410. At block 410, the system may, based on or more outcomes of the processing of block 404, train the one or more machine learning models. As described herein, at block 412, this training may involve alternating between training local model weights and training global model weights (e.g., as described and depicted in FIG. 3).

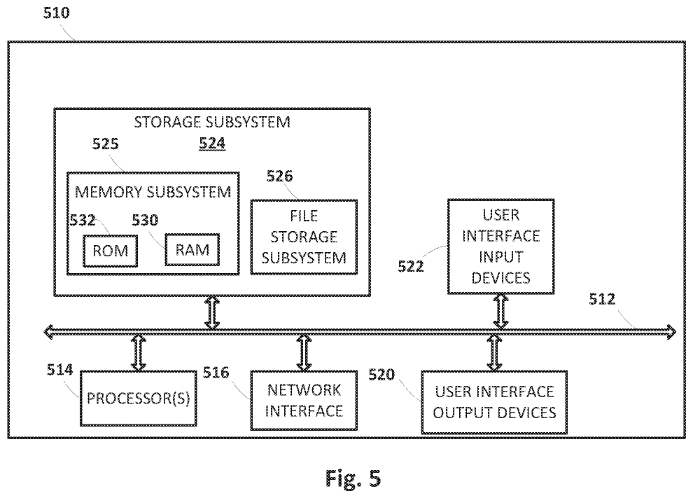

FIG. 5 is a block diagram of an example computing device 510 that may optionally be utilized to perform one or more aspects of techniques described herein. Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the method of FIG. 4, as well as to implement various components depicted in FIGS. 1-3.

These software modules are generally executed by processor 514 alone or in combination with other processors. Memory 525 used in the storage subsystem 524 can include a number of memories including a main random access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03. It should be understood that certain expressions and reference signs used in the claims pursuant to Rule 6.2(b) of the Patent Cooperation Treaty (“PCT”) do not limit the scope.

What is claimed is:

1. A method implemented using one or more processors, the method comprising:
obtaining data from one or more data sources that are available in a given domain, wherein the data is in a domain-specific form that is specific to the given domain;
processing the data using one or more trained machine learning models, wherein the one or more trained machine learning models include:
a domain-specific set of weights that is tailored to the given domain, and
a global set of weights that is shared across a plurality of domains of a federated learning system; and
providing, at one or more output components, an outcome of the processing.

2. The method of claim 1, wherein the global weights are learned using a plurality of gradients computed at the plurality of domains of the federated learning system, and the domain-specific weights are learned using local gradients computed within the given domain.

3. The method of claim 2, wherein the domain-specific weights are isolated from the global weights during training.

4. The method of claim 1, wherein the domain-specific weights correspond to an affine transform.

5. The method of claim 1, wherein one or more of the trained machine learning models comprises a convolutional neural network.

6. The method of claim 1, wherein the domain-specific set of weights and the global set of weights are incorporated into a single trained machine learning model of the one or more trained machine learning models during the processing.

7. The method of claim 1, wherein the domain-specific set of weights and the global set of weights are learned during combined training of one or more of the trained machine learning models.

8. The method of claim 1, wherein two or more of the obtaining, processing, and providing are performed by a computing device associated with the given domain.

9. A method for federated learning using one or more processors of a federated learning system, the method comprising:
obtaining data from one or more data sources that are available in a given domain, wherein the data is in a domain-specific form that is specific to the given domain;
processing the data using one or more machine learning models, wherein the one or more trained machine learning models include:
a global set of weights that is shared across a plurality of domains of the federated learning system, and
a domain-specific set of weights that is isolated from the global set of weights; and
based on one or more outcomes of the processing, training the one or more machine learning models.

10. The method of claim 9, wherein the training includes alternating between updating the global set of weights and updating the domain-specific set of weights.

11. The method of claim 10, wherein the global set of weights are held constant during training of the domain-specific set of weights, and the domain-specific set of weights are held constant during training of the global set of weights.

12. The method of claim 10, wherein updating the global set of weights includes:
computing a local gradient for the global set of weights using the data obtained from the one or more data sources available in the given domain; and
transmitting data indicative of the local gradient to a federated learning central server, wherein the federated learning central server uses the local gradient and other local gradients computed in other domains participating in the federated learning to train the global set of weights.

13. The method of claim 9, wherein one or more of the machine learning models comprises a convolutional neural network.

14. The method of claim 9, wherein the domain-specific weights correspond to a differentiable function.

15. A system comprising one or more processors and memory storing instructions that, in response to execution by the one or more processors, cause the one or more processors to perform the method of claim 1.
